(19) United States
(12) Patent Application Publication
(10) Pub. No.: US 2009/0283054 A1
(43) Pub. Date: Nov. 19, 2009

(54) PET TRAINING SYSTEM AND DEVICE AND METHOD THEREOF

(76) Inventor: Trish Reyes, Norcross, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/465,187

(22) Filed: May 13, 2009

Related U.S. Application Data
(60) Provisional application No. 61/052,771, filed on May 13, 2008.

(51) Int. Cl. A01K 15/02; A01K 29/00

(52) U.S. Cl. 119/708; 119/712; 119/719

(57) ABSTRACT

A pet training system and device, and method thereof, wherein a physical barrier protects a door from pet claw and chime damage, wherein the physical barrier is soft and safely constructed for pet contact without risk of injury, wherein a plurality of percussive tones are generated by pet contact, wherein device design facilitates convenient transport and installation on essentially any doorknob, and wherein a training DVD facilitates user understanding of house training methods incorporating the device.

### CROSS-REFERENCE AND PRIORITY CLAIM TO RELATED APPLICATION

To the fullest extent permitted by law, the present U.S. Non-Provisional patent application claims priority to and the benefit of United States Provisional patent application entitled “Pet Training System and Device and Method Thereof,” filed on May 13, 2008, on behalf of inventor Trish Reyes, and having assigned Ser. No. 61/052,771.

### FIELD OF THE INVENTION

The present invention relates generally to pet training devices, and more particularly, to a pet training system and device, and method thereof, whereby a pet can easily indicate a desire to go outdoors via physical contact with a doorknob-hung device, whereby the construction of the device serves to protect the door surface from damage, to protect the pet from inadvertent injury, and to facilitate convenient transport and easily adaptable installation, and wherein the audible signal from the device is multi-tonal and, therefore, discernable even to those with tone-focused auditory deficiencies.

### BACKGROUND OF THE INVENTION

The popularity of pet ownership continues to soar. Many people enjoy the loyalty and companionship that pets can offer. In fact, it has been established that life longevity can be extended through pet ownership. Nevertheless, caring for a pet, such as a dog, does require commitment.

For example, upon initial adoption of a puppy, the new owner is faced with the task of training the dog to go outside to urinate or to have bowel movements. Even upon completion of the training, however, the owner continues to be called upon to render the outdoors accessible to the dog. Pet owners with suitably protected property frequently choose to install specially sized pet doors to enable their pets to enter and exit as desired. Those without pet doors must either open the door each time the dog needs to enter and to exit, or must walk the dog on a leash if no protected space is available for unsupervised and/or untethered pet access. Either way, whether a leashed walk is required or the door must simply be opened and closed, the dog must first communicate the desire to go out to the owner.

Dogs can exhibit a variety of behaviors as a means of communicative expression. One such manner is scratching on a door. While scratching can notify the pet owner of the dog's desire to go out, it can also damage the surface of the door and/or serve to injure the pet, such as via splinters or the like. Further, door scratching can frequently be an ineffective communication means because the sound can be very low and/or hard to discern or notice. To attempt to overcome these disadvantages, several types of devices have been proposed.

First, pet doorbell devices have been proposed for installation in an area accessible by a pet so that a dog can activate an electronic doorbell transmitter with his paw. This can be an effective concept relative to notification; however, because it is not related to or necessarily installed on a door, there is no protective barrier component for preventing door scratching damage should the dog paw at the door surface while waiting for the door to open. Also, because this type of pet doorbell typically requires permanent installation, it is not portable and remains therefore unavailable for use during travel.

Scratch damage barriers have been described to function to block animal access to the surface of a door via installation of elongate panels, typically hung from a doorknob. While such panels can provide physical protection from claw damage to a door, no sound feature is provided to facilitate communication by the animal. Other devices have been described that hang from a doorknob, wherein a bell, or plurality of bells, hang therefrom in order to generate sound following contact from the pet. However, such known devices are disadvantageous in view of the present invention.

Therefore, it is readily apparent that there is a need for a pet training system and device, and method thereof, wherein a physical barrier protects a door from pet claw damage, wherein the physical barrier is soft and safely constructed for pet contact without risk of injury, wherein a plurality of percussive tones are generated by pet contact, and wherein device design facilitates convenient transport and installation on essentially any doorknob, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a pet training system and device, and method thereof, whereby a pet can easily indicate a desire to go outdoors via physical contact with a doorknob-hung device, whereby the construction of the device serves to protect the door surface from damage, to protect the pet from inadvertent injury, and to facilitate convenient transport and easily adaptable installation, and wherein the audible signal from the device is multi-tonal and therefore discernable even to those with tone-focused auditory deficiencies.

According to its major aspects and broadly stated, in its preferred form, the present invention is a pet training system and device, and method thereof, wherein a physical barrier protects a door from pet claw damage, wherein the physical barrier is soft and safely constructed for pet contact without risk of injury, wherein a plurality of percussive tones are generated by pet contact, and wherein device design facilitates convenient transport and installation on essentially any doorknob.

More specifically, the device of the present invention in its preferred form is a segmented, elongate padded fabric pillow with multi-tone bells safely and securely attached thereto. This lightweight device facilitates utilization by and training of dogs of all sizes, wherein the padding protects the door not only from pet damage, but also from scratch damage from bell contact. A strap may extend the length of the elongate pillow, positioned within the interior of the segmented, padded sections, wherein lengths of a strap extend outwardly from each end of the device, even if not extended fully therethrough. Such manner of construction enables provision of a support extension, such as for attaching to a doorknob, and an accessory extension, such as for attaching a toy or bell to hang from the base of the device, wherein the internally-extended lengthwise strap further prevents removal of either extension from the elongate pillow because no seam or attachment point exists therebetween to be susceptible to inadvertent failure.

The support extension end of the strap forms a tie string with a simple loop defined at the end thereof, wherein the tie string may be used to attach the pillow to a doorknob such that the pillow is suspended and rests against a door. The accessory extension end of the strap forms a small loop positioned at the base of the device during hanged installation, thereby allowing attachment of various items, such as additional bells or chimes, or toy or other pet attractants. In some applications, a second pillow could be attached to the accessory extension end of a first pillow, such as to accommodate oversized door configurations and/or very small pets.

The segmenting of the stuffed fabric member permits the device to be folded at the intersections of adjacent sections, thus facilitating convenient transport, and also enabling minimized dimensions for packaging and shipping following manufacture. The covering of the stuffed fabric member may be pet related, may be coordinated with the décor preferences of the user, and/or a user may provide a photograph, such as of the pet, for silkscreen or other suitable application to the pillow exterior.

The inclusion of bells or other chimes of different and/or varying tones at peripheral portions near the divisions between the segments is designed to avoid inhibition of foldability or portability. Provision of chimes with different tone or pitch ensures that various users with different hearing abilities can hear the bells. In order to securely attach the bells in a manner that allows the door to be protected from inadvertent bell scratches, that prevents the dog from getting claws caught therein, and that allows folding of the device, the bells may be attached with a woven cotton rope that is stitched across the fold line between each padded segment.

The pet training system and device, and method of the present invention also comprises a DVD training video, wherein house training techniques are provided, including a general training plan and specific directions for training with the padded, multi-tonal device of the present invention.

Thus, a feature and advantage of the present invention is its ability to facilitate house training of a pet.

Another feature and advantage of the present invention is its ability to enable a pet to easily indicate a desire to go outdoors via physical contact with a door-hangable device, whereby the construction of the device serves to protect the door surface from damage and also to protect the pet from inadvertent injury.

Yet another feature and advantage of the present invention is its ability to enable a pet to easily indicate a desire to go outdoors via physical contact with a door-hangable device, wherein the audible signal from the device is multi-tonal and therefore discernable even to those with tone-focused auditory deficiencies.

Still another feature and advantage of the present invention is its ability to be easily folded and transported for use at a plurality of locations.

Yet still another feature and advantage of the present invention is its ability to be securely and removably installed on virtually any size and shape doorknob.

Still another feature and advantage of the present invention is its ability to provide protection to the surface of a door from inadvertent scratching by the bells on-board the device, as well as from scratching by a pet.

Yet still another feature and advantage of the present invention is its ability to allow for safe contact by a pet with minimized risk of inadvertent claw engagement and potential injury therefrom.

Another feature and advantage of the present invention is its ability to be inexpensively manufactured, packaged and shipped.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a front view of a pet training system component, a door-hanging device, according to the preferred embodiment of the present invention;

FIG. 2 is a perspective view of the device of FIG. 1, showing a folded configuration;

FIG. 3 is a front view of the device of FIG. 1, showing the device hanging from a doorknob;

FIG. 4a is a plan view of a pet training system component, a door-hanging device, according to an alternate embodiment of the present invention;

FIG. 4b is a plan view of a pet training system component, a door-hanging device, according to an alternate embodiment of the present invention;

FIG. 4c is a plan view of a pet training system component, a door-hanging device, according to an alternate embodiment of the present invention; and

FIG. 5 is a plan view of a pet training system component, a DVD, according to a preferred embodiment of the present invention.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

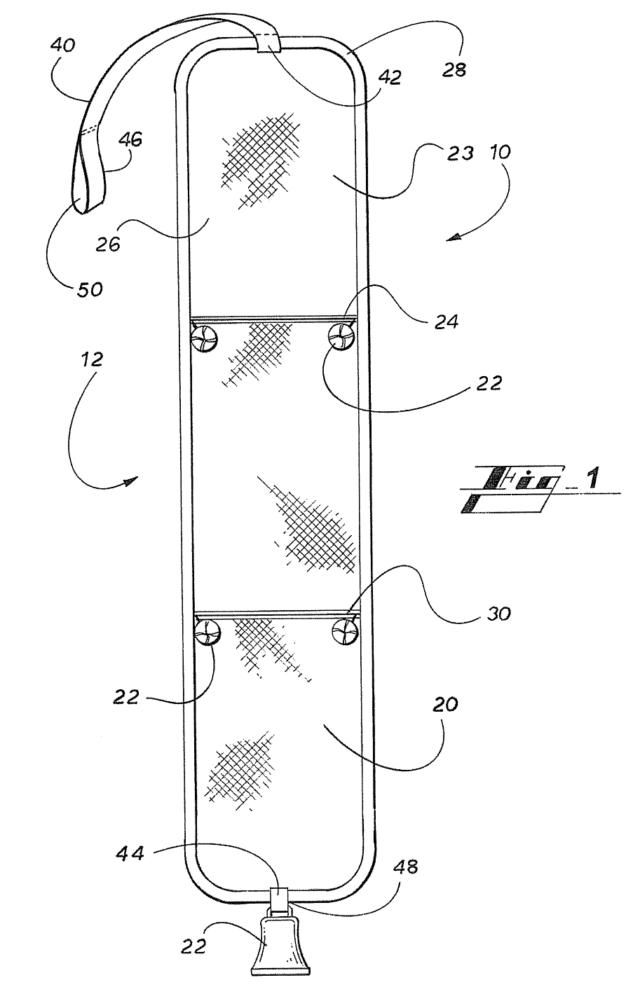

Referring now to FIGS. 1-5, the present invention in the preferred embodiment is pet training system and device 10, and method thereof, comprising door-hangable device 12 and training materials 14, wherein door-hangable device 12 is preferably a segmented, elongate padded fabric pillow 20 with plurality of multi-tone bells 22 safely and securely attached thereto, and training materials 14 is preferably a DVD with contents more fully discussed hereinbelow.

The preferred segmented, elongate padded fabric pillow 20 that is the primary component of door-hangable device 12 is a stuffed, fabric-covered member, formed in and/or divided into a plurality of sections 23 such that door-hangable device 12 is foldable at intersections 24 of adjacent sections 23. Each section 23 is preferably constructed with a foam filler to create a soft and light training mechanism. It should be understood that while foam is the preferred filler, any suitably performing filler could be alternately utilized, such as, for exemplary purposes only, puffed cotton, spun nylon, styrofoam pellets, straw, rice, or the like, wherein filling characteristics further preferably include safety relative to accidental pet ingestion.

The preferably fabric covering 26 of door-hangable device 12 may be printed with a pet-related theme, may be coordinated with the décor preferences of the user, and/or a user may provide a photograph, such as of the pet, for silkscreen or other suitable application to the exterior of padded fabric pillow 22. Further, alternate coverings could also be utilized, such as lightweight carpet, woven rope, or the like, wherein long term resistance to regular scratching, such as from a cat, could be enhanced. Further, while it is preferred that fabric covering 26 is securely and permanently closed via periphery binding 28, fabric covering 26 could also be removable, such as via snaps or a zipper and could be washable.

Nonetheless, in the preferred configuration, the elongated nature and soft pillow structure of fabric pillow 20 allows hanging installation, supported by a door knob, and effectively forms a protective, force-absorbing physical barrier that prevents damage to the door, both from animal scratching and potentially damaging physical contact with bells 22, and at the same time defines a safe and soft location for pet contact without risk of injury. The lightweight nature of door-hangable device 20 not only prevents stress on the supporting door knob, but also allows dogs of all sizes to be able to manipulate plurality of multi-tone bells 22 in order to notify the pet owner of the desire to go outside.

The segmenting of stuffed fabric member 20 permits door-hangable device 12 to be folded at intersections 24 of adjacent sections 23, thus facilitating convenient transport, and also enabling minimized dimensions for packaging and shipping following manufacture. It is preferred that door-hangable device 12 be defined in three sections 23, as depicted in FIGS. 1-3, 4b-4c, to allow for easy folding and minimal folded bulk. However, one skilled in the art would readily recognize that fewer sections 23, such as two, or more sections 23, such as four or more, could also be included.

Plurality of bells 22 or other chimes or noise-making devices are preferably attached to elongated, padded pillow 20 proximate the periphery and near intersections 24 between adjacent sections 23 of pillow 20. In order to securely attach bells 22 in a manner that allows the door to be protected from inadvertent bell scratches, that prevents the dog from getting claws caught therein, and that allows folding of door-hangable device 12, bells 22 may be attached with woven cotton rope 30, preferably stitched across each intersection 24, proximate the fold line between each padded segment 23. The inclusion of bells 22 or other chimes of different and/or varying tones at peripheral portions near the divisions between segments 23 is thus primarily designed to avoid inhibition of foldability or portability.

Provision of chimes or bells 22 with different tone or pitch ensures that various users with different hearing abilities can hear the bells, wherein a plurality of percussive tones are generated by pet contact such that the audible signal from door-hangable device 12 is multi-tonal, rendering the signal discernable even to those with tone-focused auditory deficiencies. Preferably, pet training system and device 10 offers two different tones of bells 22; however, essentially any plurality of tones or chimes could be utilized in order to enhance successful user sound recognition. Additionally, although any suitable material or design could be utilized, it is preferred that plurality of bells 22 are of a nickel finish in order to avoid tarnishing thereof.

In one embodiment, strap 40, or lanyard, extends the length of elongate pillow 20, preferably positioned within the interior of each segmented, padded section 23, and extends outwardly from each end 42, 44 of door-hangable device 12. Such manner of construction enables provision of support extension 46, proximate first end 42, such as for attaching to a doorknob, and accessory extension 48, proximate second end 44, such as for attaching a toy or bell to hang from the base, second end 44, of door-hangable device 12, and yet further prevents removal of either extension 46, 48 from elongate pillow 20 because in this preferred embodiment, no seam or attachment point exists therebetween to be susceptible to inadvertent failure. Thus, in the preferred configuration, strap 40 is one solid piece of a woven cotton/polyester blend twill tape that runs vertically through the hanged length of door-hangable device 12, wherein although other materials could be utilized, twill tape is preferred for its combination of softness and strength. However, it is intended that, in another embodiment, door hangable device could be configured without strap 40 extending therethrough, wherein support extension 46 would be attached to elongate pillow 20 proximate first end 42, in order to be used such as for attaching to a doorknob, and accessory extension 48 would be attached to elongate pillow 20 proximate second end 44, in order to be used such as for attaching a toy or bell to hang from the base, second end 44, of door-hangable device 12.

Support extension 46 is preferably stitched with loop 50 defined thereon, wherein loop 50 may be slipped directly over a door knob or handle, or wherein a length of strap 40 may be fed through loop 50 to define a slip-loop or tie string of adjustable dimensions in order to accommodate and secure to virtually any size door knob. Such manner of installation positions door-hangable device 12 such that elongate pillow 20 is suspended and rests against a door, whereby a pet may hit pillow 20, such as with a paw or tail, or simply may bump into pillow 20 to create a noise indicating that the pet needs to go outside. At the opposing end 44, accessory extension 48 is preferably threaded through a bell 22 and stitched closed. However, in alternate configurations, accessory extension 48 may remain unattached and any of a plurality of accessories may be tied or otherwise attached thereto. For example, additional or alternate bells or chimes, toys or other pet attractants, or even a second door-hangable device 12 could be alternately secured to accessory extension 48, wherein, for example, the dual-device configuration allows pet training system and device 10 to adapt to the size of any door and/or pet.

The preferred pet training system and device 10, and method of the present invention also comprises a DVD training video, as preferred training materials 14, shown in FIG. 5. Content of training materials 14 preferably comprises house training techniques, including a general training plan and specific directions for training with padded, multi-tonal door-hangable device 12 of the present invention. Thus, training materials 14 are intended to train the pet owner on specific house training techniques based upon door-hangable device 12.

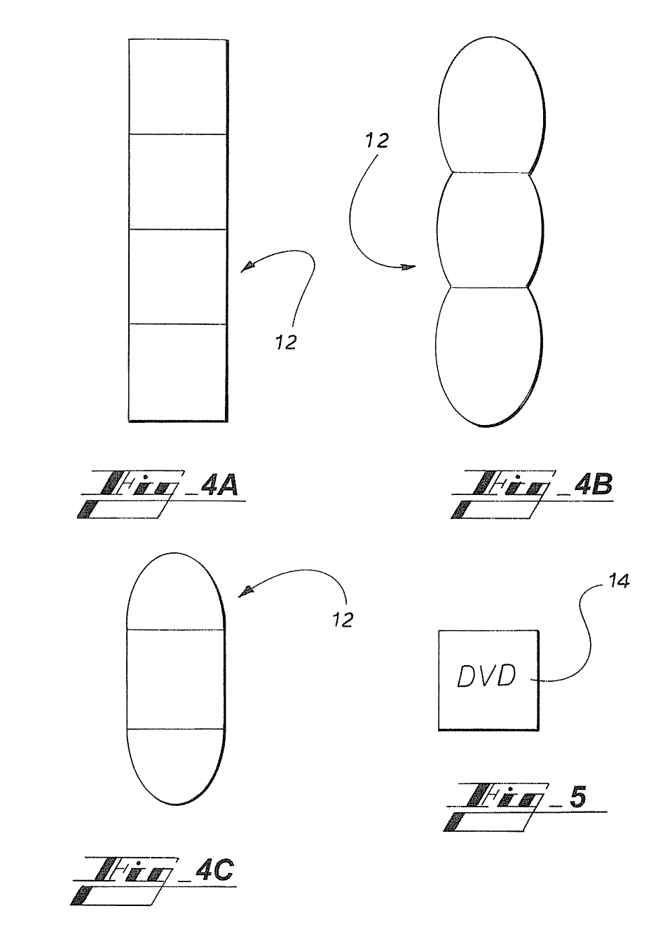

In alternate embodiments, as shown in FIGS. 4a-c, in lieu of rectangular with rounded edges, the peripheral shape of elongate pillow 20 can be that of a full rectangle with squared edges, circular, oval, or any other shape desirable to a user.

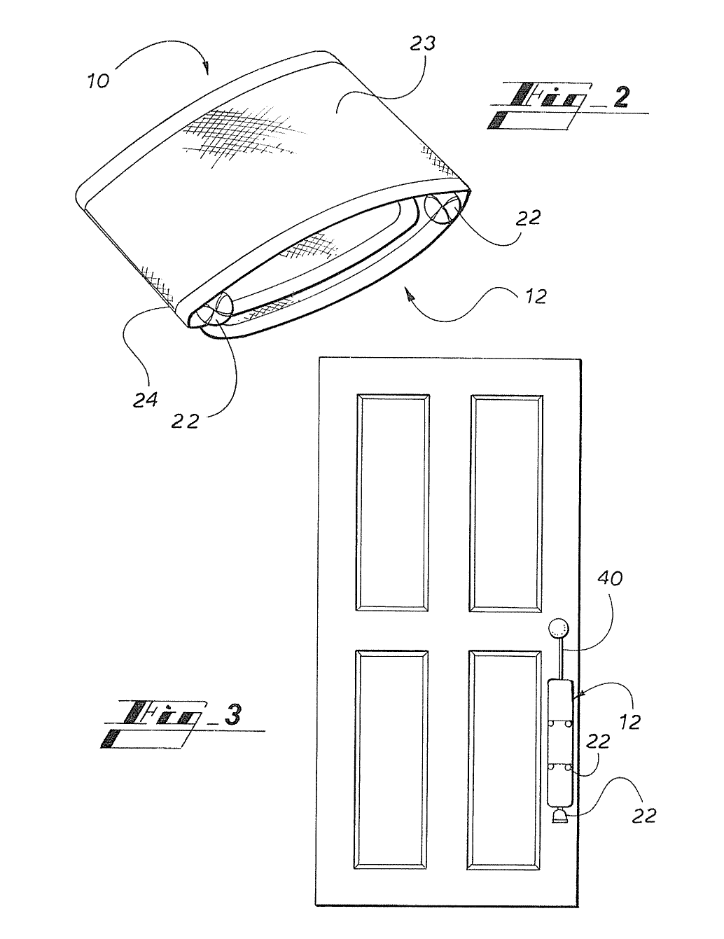

In the preferred use, tie string or support extension 46 is looped about a door knob, as depicted in FIG. 3, such that elongate, stuffed pillow 20 is suspended and rests against the door. When the pet desires to go outside, the pet may simply hit or bump pillow 20, wherein multi-tonal bells 22 will be activated to generate an audible signal. For transport, support extension 46 is removed from the door knob, and elongate, stuffed pillow 20 is folded along intersections 24, as depicted in FIG. 2, forming a compact and portable configurations. It is envisioned that a carrying case could be provided, either integral or separate from door-hangable device 12.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A pet training system, comprising:
training materials;
an elongate, padded, door-hangable device with at least two different tone bells secured thereto.

2. The pet training system of claim 1, wherein said elongate, padded, door-hangable device further comprises an internally-extended lengthwise strap.

3. The pet training system of claim 2, wherein said internally-extended lengthwise strap is seamlessly related to said elongate, padded, door-hangable device.

4. The pet training system of claim 1, wherein said elongate, padded, door-hangable device further comprises a covering.

5. The pet training system of claim 4, wherein said covering is selected from the group consisting of rope, carpet, or fabric.

6. A pet training device, comprising:
a segmented, elongate padded fabric pillow;
a plurality of chimes attached proximate said segments of said elongate padded fabric pillow, wherein at least one chime of said plurality of chimes has a first pitch and at least one other chime has another pitch; and
a strap extending outwardly from each end of said elongate padded fabric pillow,
wherein said pet training device is seamlessly configured to avoid entanglement of a pet claw.

7. The pet training device of claim 6, wherein said strap extends from a first outwardly positioned strap end, extends within an interior of said segmented, elongate pillow, and extends to a second outwardly positioned strap end.

8. The pet training device of claim 7, wherein said first outwardly positioned strap end is adapted for attachment to a doorknob and wherein said second outwardly positioned strap end is adapted to carry an accessory.

9. The pet training device of claim 8, wherein said accessory is a pet toy.

10. The pet training device of claim 7, wherein a first end of said strap is a support extension for said pet training device.

11. The pet training device of claim 12, wherein said support extension forms a tie string with a loop.

12. The pet training device of claim 8, wherein said second accessory extension strap end forms a small loop positioned at a base of said pet training device.

13. The pet training device of claim 12, further comprising a second elongate padded pillow, wherein said second elongate padded pillow is attached to said small loop.

14. A method of pet training, comprising the steps of:
obtaining a physical barrier member constructed of soft materials and dimensioned to protect the door from pet claw damage, and with a plurality of percussive tone elements carried by said physical barrier member, wherein arrangement of said plurality of percussive tone elements is adapted to facilitate generation of a plurality of percussive tones upon contact by a pet with said physical barrier member;
hanging said physical barrier member on a doorknob of a door;
encouraging a pet to indicate a desire to go outdoors by physical contact with said physical barrier member.

15. The method of pet training of claim 14, wherein said physical barrier member is a stuffed fabric member with foldable segments.

16. The method of pet training of claim 15, wherein an outer surface of said fabric member carries an artistic rendering of a pet.

17. The method of pet training of claim 14, wherein each of said plurality of percussive tone elements is positioned proximate a foldable segment of said stuffed fabric member.

18. The method of pet training of claim 17, further comprising a woven cotton rope stitched across a fold line between said segments, wherein said plurality of percussive tone elements are secured by said woven cotton rope.

19. The method of pet training of claim 14, further comprising a DVD training video with house training techniques, said techniques further comprising a general training plan and a plurality of specific directions for training with said physical barrier member.

20. The method of pet training of claim 14, further comprising a carrying case.
